(19) United States
(12) Patent Application Publication
(10) Pub. No.: US 2008/0237402 A1
(43) Pub. Date: Oct. 2, 2008

(54) Aircraft trim safety system and backup controls

(76) Inventors: Marc Ausman, Albuquerque, NM (US); Kevin DeVries, Albuquerque, NM (US); Jake Dostal, Albuquerque, NM (US)

Correspondence Address: V. Gerald Grafe, Esq., P.O. Box 2689, Corrales, NM, 87048, US

(21) Appl. No.: 12/021,022

(22) Filed: Jan. 28, 2008

Related U.S. Application Data
(63) Continuation-in-part of application No. 11/311,060, filed on Dec. 19, 2005.
Application No. 11/311,060 is a continuation-in-part of application No. 11/875,813, filed on Oct. 19, 2007.
Application No. 11/875,813 is a continuation-in-part of application No. 11/875,815, filed on Oct. 19, 2007.
Application No. 11/875,815 is a continuation-in-part of application No. 11/875,816, filed on Oct. 19, 2007.
Application No. 11/875,816 is a continuation-in-part of application No. 11/875,818, filed on Oct. 19, 2007.
Application No. 11/875,818 is a continuation-in-part of application No. 11/875,819, filed on Oct. 19, 2007.

(51) Int. Cl. B64C 13/12

(52) U.S. Cl. 244/229

(57) ABSTRACT

Methods and apparatuses that control trim of an aircraft even in the presence of conflicting trim inputs, for example by disabling the trim input switches on the aircraft when conflicting switch inputs are received. When conflicting switch inputs are received and certain time conditions are met, the controller can disable the switch inputs and provide a backup and independent means to control the trim circuitry. The pilot can be allowed to re-enable the disabled inputs.

### CROSS REFERENCE TO RELATED APPLICATIONS

This application claims the benefit as a continuation-in-part of the following U.S. patent applications, each of which is incorporated herein by reference: Ser. No. 11/311,060, filed Dec. 19, 2005, Ser. No. 11/875,813, filed Oct. 19, 2007; Ser. No. 11/875,815, filed Oct. 19, 2007; Ser. No. 11/875,816, filed Oct. 19, 2007; Ser. No. 11/875,818, filed Oct. 19, 2007; and Ser. No. 11/875,819, filed Oct. 19, 2007.

### FIELD OF THE INVENTION

This invention relates to the field of aircraft control, and more specifically to systems that provide for control of the adjustment of trim control surfaces of an aircraft.

### BACKGROUND OF THE INVENTION

The present invention relates to a system for controlling a trim tab for an aircraft control surface, and providing backup control methods and a system to disable unsafe control inputs caused by faulty wiring or switches.

Airplanes commonly have a tab on some of the aerodynamic surfaces of said airplane, such as the rudder, the elevators, the ailerons, etc. Such tabs are intended to alter the maneuvering forces that the pilot would have to exert on the aerodynamic surfaces in order to turn them if tabs were not present.

Trim tabs in some aircraft are mechanically controlled via cables or hydraulic actuators. Trim tabs in some aircraft are controlled by electric servomotors. Some aircraft have trim tabs controlled mechanically and trim tabs controlled by electric servomotors. Typically, the electric servo motor can be a DC motor whose direction is controlled by changing the polarity of the electrical power or can be a stepper motor that is controlled by a circuit designed to run the stepper motor in one direction or the other. Some references related to control of aircraft trim surfaces include U.S. Pat. No. 5,913,492, System for controlling an aircraft control surface tab; U.S. Pat. No. 6,325,333, Aircraft pitch-axis stability and command augmentation system; and U.S. Pat. No. 7,021,587, Dual channel fail-safe system and method for adjusting aircraft trim.

If the electric switches that provide pilot and/or co-pilot input to the trim control system fail in a manner that causes the trim to run inadvertently, the pilot has little recourse other than to remove power from the trim motor, usually by “pulling” a circuit breaker. By the time the pilot finds the circuit breaker, if able to at all, the trim has often run far enough to cause an unsafe out-of-trim condition. Further, pulling the breaker does not allow a pilot to reset the trim tab back to a desired position. Also, in aircraft with trim control inputs for both the pilot and the co-pilot, there is a potential for conflicting trim control inputs. Accordingly, there is a need for methods and apparatuses that can provide for control of trim surfaces in the presence of switch failures, conflicting inputs, or both, and that can allow for continued control of trim surfaces after such failures or input conflicts.

### SUMMARY OF THE INVENTION

The present invention provides methods and apparatuses to mitigate the risk from unsafe trim operations, for example when un-commanded operation occurs due to shorted control wires or stuck switches, to name a few causes. The present invention comprises methods and apparatuses for determining the presence and type of un-commanded trim operation, for example by detecting conflicting switch inputs, and then responding by initiating a pre-determined set of actions and providing backup controls to a pilot. Embodiments of the present invention can provide safety systems for aircraft pitch, roll, or yaw trim, and can also be used for flap control.

Embodiments of the invention can also specifically disable the co-pilot input switches using a user interface. This can be desirable, for example, if a passenger is sitting in the co-pilot seat and the pilot does not want the passenger to inadvertently bump the trim control switch(es).

A graphical display, such as a liquid crystal display or other visual communication technology, can be provided for the pilot. Relevant information, such as trim control status and soft keys for pilot interaction can be readily communicated to the pilot using the graphical display.

An example embodiment of the present invention comprises a method of controlling trim surfaces in an aircraft, responsive to a first operator input specifying a first direction for trim adjustment, and a second operator input specifying a second direction for trim adjustment, comprising: Determining if the first input is active and the second input is inactive, and then adjusting the trim according to the first direction; Determining if the first input is inactive and the second input is active, and then adjusting the trim according to the second direction; Determining if the first input is active and the second input is active, and then not adjusting the trim in either the first or the second direction. Such an embodiment can further comprise determining if the first input and the second input are both active for a predetermined time, and if so, then not adjusting the trim regardless of the activation of the first input or the second input. Such an embodiment can also further comprise accepting a reset input, and after activation of the reset input adjusting the trim responsive to the first and second inputs. Such an embodiment can further comprise accepting a backup first input and a backup second input, and adjusting the trim responsive to the backup first input and the backup second input. In such an embodiment, when it has been determined that the first input and the second input are both active for a predetermined time, then the method can present to the user controls corresponding to the backup first input and the backup second input.

An example embodiment of the present invention can comprise a method of controlling trim surfaces in an aircraft, responsive to a trim input from a pilot, and a trim input from a co-pilot, comprising adjusting the trim such that, in the event that the pilot trim input conflicts with the co-pilot trim input, the trim is either adjusted according to the pilot trim input or the trim is not adjusted while such conflict exists. Adjusting the trim in such an embodiment can comprise, if the pilot trim input conflicts with the co-pilot trim input, adjusting the trim according to the pilot trim input. Adjusting the trim in such an embodiment can comprise, if the pilot trim input conflicts with the co-pilot trim input, not adjusting the trim while such conflict exists. Such an embodiment can, if the pilot trim input conflicts with the co-pilot trim input continuously for a predetermined period of time, not adjust the trim regardless of the pilot trim input and the co-pilot trim input. Such an embodiment can further comprise accepting a backup trim input, and adjusting the trim responsive to the backup trim input. Such an embodiment can further comprise accepting a reset input, and after activation of the reset input adjusting the trim responsive to the pilot and co-pilot trim inputs. Such an embodiment can further comprise accepting a pilot override input, and, responsive to such input, controlling the trim responsive to the pilot trim input regardless of the co-pilot trim input. Such an embodiment can further comprise providing a soft key for use as the backup trim input.

An example embodiment of the present invention comprises an apparatus to facilitate control of trim surfaces in an aircraft, comprising a control system, adapted to be placed in operable relationship with a trim surface of the aircraft, and adapted to be placed in communication with a pilot trim input subsystem, wherein the pilot trim input subsystem is capable of indicating either of two trim adjustment directions, wherein the control system is adapted to cause adjustment of the trim surface in the direction indicated by the pilot trim input subsystem if only one of the two trim adjustment directions is indicated, and to cause no adjustment of the trim surface if both of the two trim adjustment directions are indicated. The control system in such an embodiment can be further adapted to determine if both of the two trim adjustment directions are indicated, and if so, then to refrain from causing adjustment of the trim surface responsive to the pilot trim input system. The control system in such an embodiment can be further adapted to present a backup trim input to an operator, and to cause adjustment of the trim surface responsive to the backup trim input. The control system in such an embodiment can be further adapted to be placed in communication with a co-pilot trim input system, wherein the co-pilot trim input subsystem is capable of indicating either of two trim adjustment directions, and to cause adjustment of the trim surface according the co-pilot trim input system if the pilot trim input system does not indicate a conflicting trim adjustment direction. The control system in such an embodiment can be adapted to cause adjustment of the trim surface according the pilot trim input system if the pilot trim input system indicates a conflicting trim adjustment direction from that indicated by the co-pilot trim input system. The control system in such an embodiment can be adapted to cause no adjustment to the trim surface if the pilot trim input system indicates a conflicting trim adjustment direction from that indicated by the co-pilot trim input system. The control system in such an embodiment can be adapted to present a backup trim control input to an operator after detecting that the pilot trim input system and the co-pilot trim input system have indicated conflicting trim adjustment directions, and to cause adjustment of the trim control surface responsive to the backup trim control input. The control system in such an embodiment can be adapted to accept an input indicating that the co-pilot trim input system is to be disabled, and, after that input is received, then adjusting the trim responsive to the pilot trim input system without regard to the co-pilot trim input system.

### BRIEF DESCRIPTION OF THE DRAWINGS

FIG. 1 is an illustration of the components of an example apparatus according to the present invention.

FIG. 2 is an illustration of a process diagram of an example embodiment of the present invention.

FIG. 3 is a schematic illustration of a display and input apparatus suitable for use with the present invention.

FIG. 4 is a schematic illustration of an example display and associated soft keys when trim is disabled according to an example embodiment of the present invention.

FIG. 5 is a schematic illustration of an example display and associated soft keys to disable the co-pilot switch inputs according to an example embodiment of the present invention.

### DETAILED DESCRIPTION OF THE INVENTION

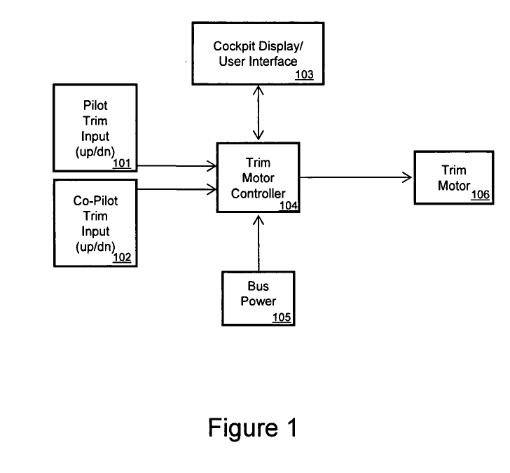

FIG. 1 is an illustration of an example apparatus according to the present invention. The aircraft's trim motor(s) are controlled by a trim motor controller 104 such as one that can read discrete switch inputs, compute control logic, interface with a user interface 103 and control the appropriate type of trim motor 106. The trim motor controller 104 can be implemented, for example, can be implemented using a microprocessor, such as those available from Intel, Atmel, PIC, or other well-known manufacturers. Pilot input switch(es) 101 and co-pilot input switch(es) 102 can be read by the microprocessor(s) in the controller 104. The trim motor controller 104 can determine which way, if any, to move the trim motor responsive to those switches. Power can be provided to the controller 104 and to the trim motors 106 via a power bus 105. The user interface 103 can vary depending on the user experience desired. As an example, the user interface can comprise a color liquid crystal screen with buttons along the perimeter. The function of the buttons can change based on the menus displayed near them on the screen. Buttons with changeable functions are sometimes known as “soft keys.”

The pilot trim input and co-pilot trim input systems can comprise a variety of switch configurations. In some embodiments each system comprises inputs for each of several trim axes. Input for each axis can comprise a single switch, two switches wired in series that must be moved together, or two switches that provide two independent inputs to the controller, as examples. For convenience, the description herein refers to a single axis; the invention can be applied to each of several axes if desired.

Some systems can have a single trim input that provides conflicting inputs; e.g., a system with only a pilot trim input system, having two independently controllable switches (one for “up”, one for “down”); or a system with only a pilot trim input system, with a switch that can fail in a manner that results in simultaneous indication of both “up” and “down”. In such systems, the trim motor controller can control the trim motors according to the trim input, except when the trim input indicates both directions simultaneously. In such situations, the controller can prevent conflicting inputs from damaging the trim motor or causing unpredictable trim adjustment by only driving the trim motor when the inputs are not in conflict. The controller can ignore conflicting inputs while they occur, and can also disable the trim inputs for a time interval after a conflict, and can provide an alert (e.g., visual or audible) indicating that a trim input conflict has occurred. The controller can provide a reset input to allow a pilot to indicate that the conflict situation has been resolved and direct the controller to resume trim control based on the trim inputs. The controller can also provide softkeys that allow for trim control, which softkeys can be configured so that conflicting trim inputs via the softkeys are impossible.

In systems with multiple trim input systems, e.g. systems with a pilot trim input system and a co-pilot trim input system, there is also the opportunity for trim control conflicts between the input from the two input systems. In one embodiment of the present invention, the controller can use the pilot input as the dominant input. If a single trim input is received (i.e., input from only the pilot or only the co-pilot), then the controller can control the trim motor according to that input. If two trim inputs are received, and they indicate the same trim control, then the controller can control the trim motor according to that input. If two trim inputs are received, and they indicate different trim controls, then the controller can control the trim input according to the input received from the pilot trim input. The controller can indicate the presence of the conflicting trim inputs, for example by a warning light or an audible tone, to alert the pilot.

In another embodiment of the present invention, the controller can determine that conflicting trim inputs represents an error or failure. In such an embodiment, if two trim inputs are received and they indicate different trim controls, then the controller can ignore the conflicting inputs and leave the trim unchanged. The controller can indicate the presence of the conflicting trim inputs, for example by a warning light or an audible tone, to alert the pilot. Embodiments of the present invention can combine two above two operations, for example by using the pilot trim input as the dominant trim input for conflicts that persist only a short time. When conflicting trim inputs are received, and the conflict persists (e.g., from a persistent failure of a trim input system) for a sufficient time (e.g., longer than a predetermined time, or longer than a predetermined time after a warning light or tone is provided), then the controller can leave the trim unchanged. The controller can provide backup trim control inputs that do not allow for conflicting inputs, that can be used generally or that are made available to the pilot when the controller has determined conflicting trim inputs. The backup trim inputs can allow the pilot to adjust the trim surfaces even after a failure of the normal trim inputs would have otherwise resulted in undesirable trim control surface configuration.

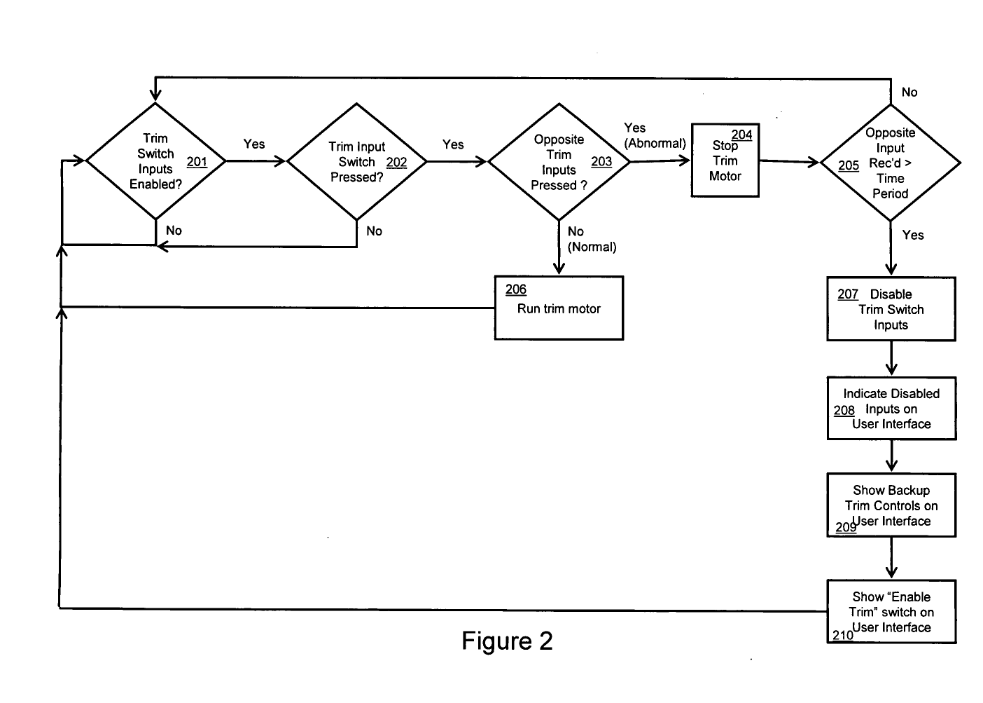

FIG. 2 is an illustration of a process diagram of control and user interface logic of an example embodiment of the present invention. The control remains in the initial state 201 as long as the trim inputs are not enabled (e.g., if they have been disabled due to the current operating mode of the aircraft, or because of a previously detected fault). If the trim inputs are enabled, and a trim input switch is pressed 202, then the system determines whether opposite or conflicting trim inputs have been received 203. If all trim inputs are in accord (i.e., only one input has been received, or multiple inputs have been received and they indicate the same trim adjustment, or, allowed in some embodiments, conflicting inputs have been received but the pilot input has been defined to currently be dominant), then the system operates the trim motor in accord with the trim input 206.

If the trim inputs are not in accord, then the system can stop the trim motor 204. If the conflicting inputs are received for more than a pre-determined period of time 205 (3 seconds, for example) then a sequence of events occurs. FIG. 2 shows one example, but other events and ordering of events can be suitable, for example to accommodate different aircraft or different pilot preferences. The pilot and co-pilot trim switch inputs can be disabled 207 (if the conflicting inputs are due to a failure, then it can be undesirable to adjust the trim based on failed inputs even if the conflict is removed). An indication of the disabled status of the trim inputs can be displayed 208 to the pilot. An audio alert or other indicator can also be presented to the pilot, and the event recorded in a record of the flight or communicated to a monitoring system. Backup controls to operate the trim can displayed 209 on a user interface. A pilot can use these controls to restore the trim to its intended position while the switch inputs are disabled. In some applications these controls can also be accessible during normal operations to provide a secondary means for trim control. A button that re-enables the trim input switches 210 can be shown on the user interface. A pilot can use that button to re-enable the usual trim input switched, for example after the pilot has cleared the cause of the conflicting trim inputs.

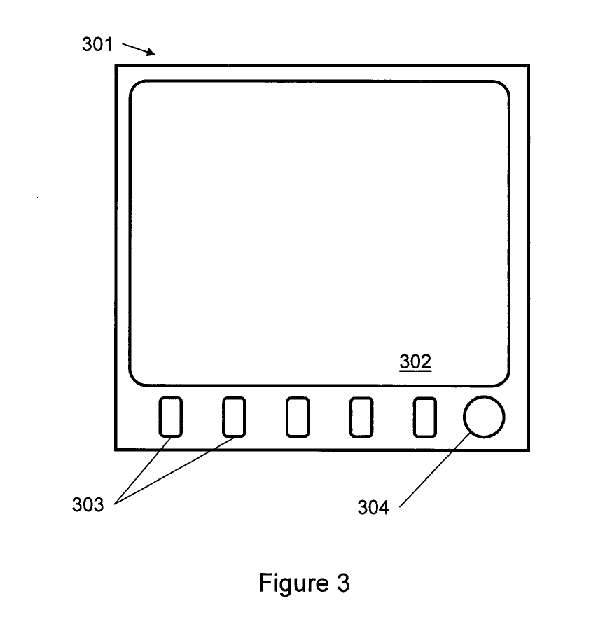

FIG. 3 is a schematic illustration of a display and input apparatus 301 suitable for use with the present invention. The apparatus comprises a visible display screen 302, such as those in contemporary use in computers, phones, and the like. The display screen 302 can be used to communicate information to a pilot, such as the current state of various aircraft operating parameters, and information relative to various trim conditions. Examples of such operations can be found in U.S. patent applications 60/853,712, filed Oct. 23, 2006; Ser. No. 11/311,060, filed Dec. 19, 2005; “Aircraft Emergency Handling”, U.S. patent application Ser. No. 11/875,813, filed on Oct. 19, 2007; “Backup Electrical Power System for Solid-State Aircraft Power Distribution Systems”, U.S. patent application Ser. No. 11/875,815, filed on Oct. 19, 2007; “Aircraft Electrical System Evaluation”, U.S. patent application Ser. No. 11/875,816, filed on Oct. 19, 2007; “Aircraft Exhaust Gas Temperature Monitor”, U.S. patent application Ser. No. 11/875,818, filed on Oct. 19, 2007; each of which is incorporated herein by reference. A physical input device such as a rotary knob 304 can mount near the display screen 302, for example to allow a pilot to adjust an operating parameter over a range, or select from a range of options displayed on the screen 302. A plurality of physical input devices such as push buttons 303 can mount near the screen 302. Each button can correspond to a specific pilot input communication; for example, one button can be used by a pilot to command the movement of the trim motor. The correspondence of buttons to input communications can also be determined based on the current communications desired. For example, the screen 302 can display information near each button, where the information provides a pilot with a specification of the action indicated by pressing that button. The information displayed and the corresponding actions can thereby be customized to the information most relevant to the current communication with the pilot, allowing a small number of buttons to accomplish a wide variety of communications. The screen 302 can be used to communicate trim information, for example to communicate to the pilot that the trim inputs are disabled, and can be used to indicate when a button 303 is available for use as a trim input.

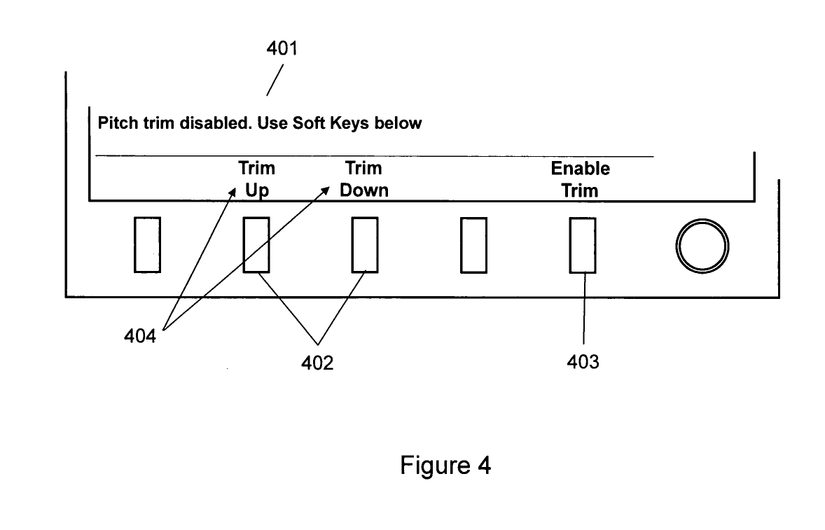

FIG. 4 is a schematic illustration of a display and associated soft keys, like that described in connection with FIG. 3, in operation when the trim is disabled. Message 401 is displayed communicating to a pilot that the switch inputs are disabled. The display also communicates to the pilot that buttons 402 are available for use as trim control inputs by displaying appropriate legends 404. The soft keys 402 can used to indicate desired adjustment of a corresponding trim control surface. When the trim switch inputs are disabled, another soft key 403 is available to allow a pilot to re-enable the trim switch inputs if desired.

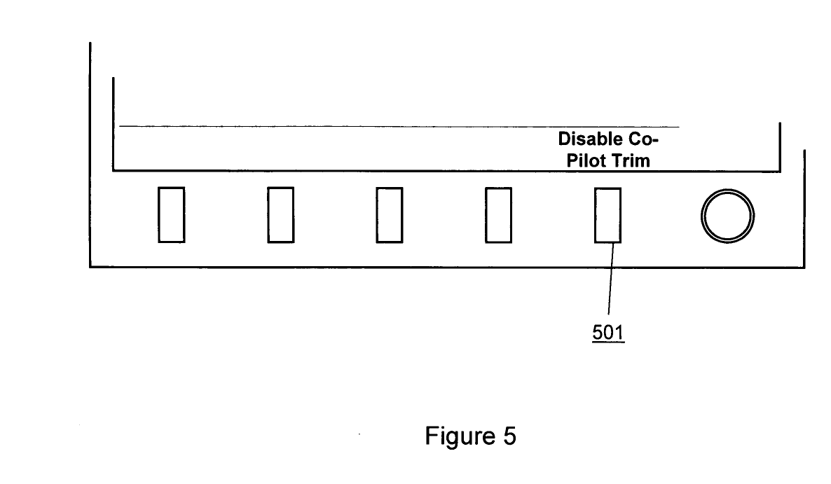

FIG. 5 is a schematic illustration of a display and associated soft keys, illustrating an embodiment of the present invention that provides a soft key that allows the co-pilot trim switches to be disabled. Soft key 501 is shown that allows a pilot to disable the co-pilot switch inputs if desired. When the co-pilot's trim is disabled, the soft key can be changed to “Enable Co-pilot Trim” to allow a pilot to re-enable the co-pilot trim input.

The particular sizes and equipment discussed above are cited merely to illustrate particular embodiments of the invention. It is contemplated that the use of the invention can involve components having different sizes and characteristics. It is intended that the scope of the invention be defined by the claims appended hereto.

We claim:

1) A method of controlling trim surfaces in an aircraft, responsive to a first operator input specifying a first direction for trim adjustment, and a second operator input specifying a second direction for trim adjustment, comprising:
a) Determining if the first input is active and the second input is inactive, and then adjusting the trim according to the first direction;
b) Determining if the first input is inactive and the second input is active, and then adjusting the trim according to the second direction;
c) Determining if the first input is active and the second input is active, and then not adjusting the trim in either the first or the second direction.

2) A method as in claim 1, further comprising determining if the first input and the second input are both active for a predetermined time, and if so, then not adjusting the trim regardless of the activation of the first input or the second input.

3) A method as in claim 2, further comprising accepting a reset input, and after activation of the reset input adjusting the trim responsive to the first and second inputs.

4) A method as in claim 2, further comprising accepting a backup first input and a backup second input, and adjusting the trim responsive to the backup first input and the backup second input.

5) A method as in claim 4, wherein, when it has been determined that the first input and the second input are both active for a predetermined time, then presenting to the user controls corresponding to the backup first input and the backup second input.

6) A method of controlling trim surfaces in an aircraft, responsive to a trim input from a pilot, and a trim input from a co-pilot, comprising adjusting the trim such that, in the event that the pilot trim input conflicts with the co-pilot trim input, the trim is either adjusted according to the pilot trim input or the trim is not adjusted while such conflict exists.

7) A method as in claim 6, wherein adjusting the trim comprises, if the pilot trim input conflicts with the co-pilot trim input, adjusting the trim according to the pilot trim input.

8) A method as in claim 6, wherein adjusting the trim comprises, if the pilot trim input conflicts with the co-pilot trim input, not adjusting the trim while such conflict exists.

9) A method as in claim 8, wherein, if the pilot trim input conflicts with the co-pilot trim input continuously for a predetermined period of time, then not adjusting the trim regardless of the pilot trim input and the co-pilot trim input.

10) A method as in claim 9, further comprising accepting a backup trim input, and adjusting the trim responsive to the backup trim input.

11) A method as in claim 8, further comprising accepting a reset input, and after activation of the reset input adjusting the trim responsive to the pilot and co-pilot trim inputs.

12) A method as in claim 6, further comprising accepting a pilot override input, and, responsive to such input, controlling the trim responsive to the pilot trim input regardless of the co-pilot trim input.

13) A method as in claim 10, further comprising providing a soft key for use as the backup trim input.

14) An apparatus to facilitate control of trim surfaces in an aircraft, comprising a control system, adapted to be placed in operable relationship with a trim surface of the aircraft, and adapted to be placed in communication with a pilot trim input subsystem, wherein the pilot trim input subsystem is capable of indicating either of two trim adjustment directions, wherein the control system is adapted to cause adjustment of the trim surface in the direction indicated by the pilot trim input subsystem if only one of the two trim adjustment directions is indicated, and to cause no adjustment of the trim surface if both of the two trim adjustment directions are indicated.

15) An apparatus as in claim 14, wherein the control system is further adapted to determine if both of the two trim adjustment directions are indicated, and if so, then to refrain from causing adjustment of the trim surface responsive to the pilot trim input system.

16) An apparatus as in claim 14, wherein the control system is further adapted to present a backup trim input to an operator, and to cause adjustment of the trim surface responsive to the backup trim input.

17) An apparatus as in claim 14, wherein the control system is further adapted to be placed in communication with a co-pilot trim input system, wherein the co-pilot trim input subsystem is capable of indicating either of two trim adjustment directions, and to cause adjustment of the trim surface according the co-pilot trim input system if the pilot trim input system does not indicate a conflicting trim adjustment direction.

18) An apparatus as in claim 17, wherein the control system is adapted to cause adjustment of the trim surface according the pilot trim input system if the pilot trim input system indicates a conflicting trim adjustment direction from that indicated by the co-pilot trim input system.

19) An apparatus as in claim 17, wherein the control system is adapted to cause no adjustment to the trim surface if the pilot trim input system indicates a conflicting trim adjustment direction from that indicated by the co-pilot trim input system.

20) An apparatus as in claim 19, wherein the control system is adapted to present a backup trim control input to an operator after detecting that the pilot trim input system and the co-pilot trim input system have indicated conflicting trim adjustment directions, and to cause adjustment of the trim control surface responsive to the backup trim control input.

21) An apparatus as in claim 17, wherein the control system is adapted to accept an input indicating that the co-pilot trim input system is to be disabled, and, after that input is received, then adjusting the trim responsive to the pilot trim input system without regard to the co-pilot trim input system.
